(19) United States
(12) Patent Application Publication
(10) Pub. No.: US 2012/0307358 A1
(43) Pub. Date: Dec. 6, 2012

(54) Color filter for generating and viewing three-dimensional colored pictures

(75) Inventors: Maximilian Baum, Koblenz (DE); Michael Schulz-Grosser, Bad Kreuznach (DE); Robert Zupka, Coram, NY (US)

(73) Assignee: Jos. Schneider Optische Werke GmbH, Kreuznach (DE)

(21) Appl. No.: 13/310,751

(22) Filed: Dec. 3, 2011

(30) Foreign Application Priority Data
Dec. 3, 2010 (DE) 10 2010 053 230.4

(51) Int. Cl. G02B 27/22; B01J 19/12

(52) U.S. Cl. 359/464; 250/492.1

(57) ABSTRACT

The invention relates to the field of 3D cinema projection using wavelength-division multiplexing. Three-dimensional color images are generated and viewed using a filter pair. Respectively differently pre-specified regions of the visible spectrum are filtered out by the two filters of the filter pair such that a plurality of delimited spectral intervals are transmitted in the blue, green and red domain of color perception. Here, the position of the transmitting intervals for the two perspective partial images is different. The respectively filtered-out regions are produced by absorption bands. The absorption bands here can be generated by a plurality of different colorants in the filter material. The filters can, for example, be disposed in glasses for viewing three-dimensional color images with two viewing openings for the eyes of an observer.

### FIELD OF THE INVENTION

The invention relates to the field of three-dimensional (3D) representation of images, for example in cinema projection. In particular, the invention relates to the field of 3D cinema projection using wavelength-division multiplexing.

### PRIOR ART

A known system for wavelength-division multiplexing for 3D cinema projection is described in EP 1 101 362 B1.

A disadvantage in the known systems for wavelength-division multiplexing is that the glasses and filters used are so expensive to produce that they must be used multiple times.

In addition, the filters used have a strong angle-dependence. The spectral position of the transmission bands of the filter depends strongly on the angle of incidence of the light. As a result, curved eyeglass lenses must be used in cinemas and, in the projector, the angles of incidence onto the filter must be kept small by necessity. Nevertheless, crosstalk between the individual channels of the actually separate images for the right and left eyes cannot be ruled out completely.

### OBJECT

It is the objective of the invention to improve wavelength-division multiplexing for 3D cinema projection.

### SOLUTION

This object is achieved by the invention having the features of the independent claim. Advantageous developments of the invention are characterized in the dependent claims. The wording of all claims is hereby included in this description by reference. The inventions also comprise all practical and in particular all indicated combinations of independent and/or dependent claims.

For the purpose of achieving the object, a filter pair for generating and viewing three-dimensional color images is proposed herein respectively differently pre-specified regions of the visible spectrum are filtered out by the two filters of the filter pair such that a plurality of delimited spectral intervals are transmitted in the blue, green and red domain of color perception, with the position of the transmitting intervals for the two perspective partial images being different; and herein the filtered-out regions are produced by absorption bands.

The term filters here refers to filters composed of a material that has specific transmissive and absorptive spectral properties.

The filter pair proposed eliminates the angle dependency of the known filters for wavelength-division multiplexing, which are based on interference using dichroic layers. As a result, crosstalk between the channels for the two eyes is eliminated.

The filters produced according to the invention can be manufactured very cost-effectively. Glasses made thereof can be used as disposable glasses, resulting in diverse hygienic advantages.

The two filters can, for example, be manufactured from the material of a color slide film. Slide film, transparency film or reversal film refers to any photographic film that shows colors in a natural representation. Exposed and developed slide films are Suitable for the filters (see below).

The desired absorption bands in the filters can also be generated by absorption bands of a plurality of different colorants in the filter material. By way of example it is possible for three different colorant types (for RGB) to be embedded in the filter medium in each case in a suitable concentration. The concentration must be chosen such that the difference in the optical density between the transmission and absorption regions is at least 2. Otherwise the separation between the channels for the two eyes could be incomplete.

Individual method steps will be described in more detail below. The steps do not necessarily have to be carried out in the order given, and the method described below can also have other steps which are not mentioned.

Suitable as a method. for producing a filter for a filter pair are the following steps. A positive color slide film is illuminated with said plurality of delimited spectral intervals in the blue, green and red domain of color perception, in which the respective filter is intended to transmit.

The slide film can for example be illuminated successively with the colors of the desired transmission bands, e.g. using a white-light source with the aid of a monochromator. The illumination can also take place, however, using a. filter having the same desired transmission spectrum as the filter to be produced. Illumination in that case is effected with a white-light source through a suitable filter onto the slide film. In this way it is possible to use an already manufactured filter to produce the next filters.

The slide film is developed as usual after illumination.

The proposed filter pairs can be used to prepare glasses for viewing three-dimensional color images with two viewing openings for two eyes. Here, one filter of the filter pair is used for one viewing opening of the glasses. The other filter of the filter pair is used for the other viewing opening.

Other details and features emerge from the following description of preferred exemplary embodiments in conjunction with the dependent claims. Here, the respective features can be realized alone or in combination with one another. The possibilities of achieving the object are not limited to the exemplary embodiments.

The exemplary embodiments are shown schematically in the FIGURE, in which specifically:

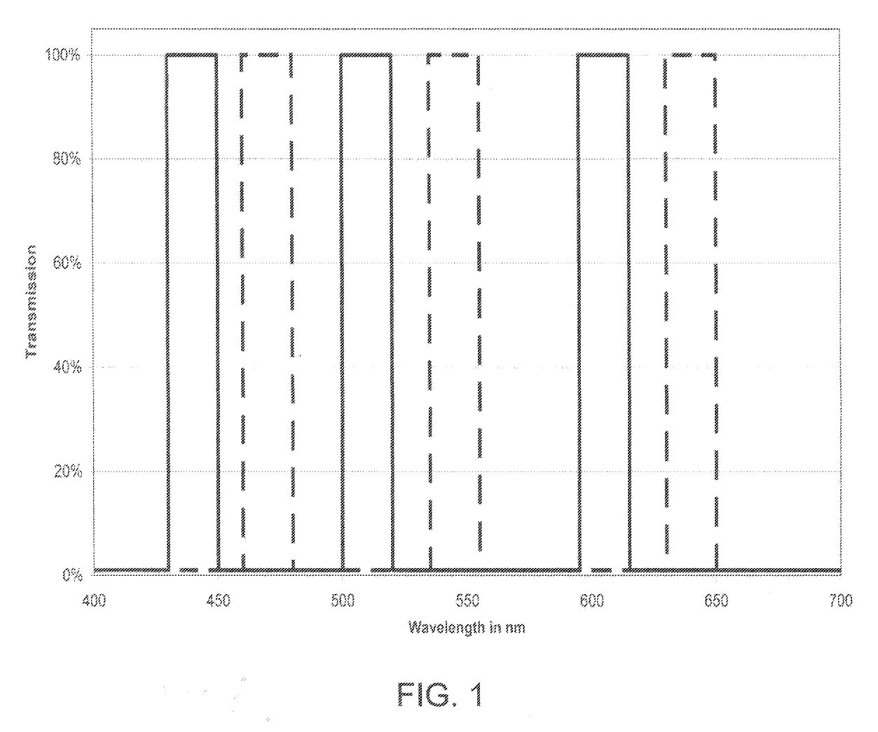

FIG. 1 shows an exemplary schematic transmission spectrum for two filters of a filter pair.

FIG. 1 shows an exemplary schematic transmission spectrum for two filters of a filter pair. The solid line designates the filter of the right eye and the dashed line designates the transmission spectrum of the filter of the left eye.

1. A filter pair for generating and viewing three-dimensional color images,
wherein respectively differently pre-specified regions of the visible spectrum are filtered out by the two filters of the filter pair such that a plurality of delimited spectral intervals are transmitted in the blue, green and red domain of color perception, with the position of the transmitting intervals for the two perspective partial images being different; and
wherein the filtered-out regions are produced by absorption bands.

2. The filter pair as claimed in claim 1,
wherein the two filters are manufactured from the material of a color slide film.

3. The filter pair as claimed in claim 1,
wherein the absorption bands of the filters are generated by absorption bands of a plurality of different colorants in the filter material.

4. A method for producing a filter for a filter pair as claimed in claim 2 with the following steps:
a positive color slide film is illuminated with said plurality of delimited spectral intervals in the blue, green and red domain of color perception, in which the respective filter is intended to transmit.

5. Glasses for viewing three-dimensional color images with two viewing openings for two eyes,
with one filter of the filter pair as claimed in claim 1 for one viewing opening of the glasses; and
with the other filter of the filter pair for the other viewing opening.
